(19) United States
(12) Patent Application Publication
(10) Pub. No.: US 2024/0400120 A1
(43) Pub. Date: Dec. 5, 2024

(54) CART CAPABLE OF SLIDING WITHOUT INCREASING HEIGHT

(71) Applicant: Zhejiang Pride Leisure Products Co,. Ltd., Jinhua (CN)

(72) Inventor: Benlong SUN, Jinhua (CN)

(21) Appl. No.: 18/677,229

(22) Filed: May 29, 2024

(30) Foreign Application Priority Data
May 29, 2023 (CN) 202321328197.2

(51) Int. Cl. B62B 3/00; B62B 3/02; B62B 5/06

(52) U.S. Cl. CPC B62B 3/007; B62B 3/025; B62B 5/067; B62B 2205/06

(57) ABSTRACT

A cart capable of sliding without increasing the height having a cart frame formed by a front wall, a back wall and two symmetric side walls, a bottom frame at the bottom of the cart frame, and four wheels disposed on two sides of the front wall and two sides of the back wall respectively; wherein the front wall comprises two vertical tubes, two upper fixed seats, two lower fixed seats, two sliding seats and a folding member, the upper fixed seats and the lower fixed seats are mounted at upper ends and lower ends of the vertical tubes respectively; the sliding seats are disposed around the vertical tubes and are able to slide upwards and downwards, upper and lower ends of each same side of the folding member are riveted to the corresponding upper fixed seat and the corresponding sliding seat respectively.

### BACKGROUND OF THE INVENTION

### 1. Technical Field

The invention belongs to the technical fields of carts, and particularly relates to a cart capable of sliding without increasing the height.

### 2. Description of Related Art

Carts used to transfer light articles within a short distance are extremely conveniently in places where motor vehicles are inapplicable. Chinese Patent Publication No. CN103895672B discloses a beach cart, which comprises a frame, a handlebar disposed in front of the frame, and wheels fixed at the bottom of the frame, wherein the frame comprises a bottom frame, a front frame disposed on the front of the bottom frame, a back frame disposed on the back of the bottom frame, and side frames disposed on two side faces of the bottom frame, the two side frames are symmetric with respect to the bottom frame and each comprise at least two X-shaped assemblies which are symmetric with each other, and multiple articulated joints used for connecting every two adjacent X-shaped assemblies on the same side, and each X-shaped assembly comprises a first oblique beam and a second oblique beam which are articulated through an articulated shaft in the middle of the X-shaped assembly, one end of the first oblique beam is articulated with the first oblique beam of one adjacent X-shaped assembly through the articulated shaft, and the other end of the first oblique beam is articulated with the front frame or the back frame through a lower bracket of the bottom frame or is articulated with the first oblique beam of the other adjacent X-shaped assembly through the articulated shaft; one end of the second oblique beam is articulated with the second oblique beam of one adjacent X-shaped assembly through the articulated shaft, and the other end of the second oblique beam is articulated with the front frame or the back frame through an upper bracket of the bottom frame or is articulated with the second oblique beam of the other adjacent X-shaped assembly through the articulated shaft; the beach cart further comprises: first connectors fixedly connected to the lower brackets; second connectors fixedly connected to the upper brackets; third connectors fixedly connected to support legs of the bottom frame; vertical beams each having an end articulated with the corresponding third connector and an end articulated with a rear wheel; and fourth connector disposed around the vertical beams, capable of sliding with respect to the vertical beams, connected to the first connectors or the second connectors to fix the rear wheels when the vertical beams are clamped in the first connectors or the second connectors. The beach cart can be unfolded when used and folded when not used; however, the overall height of the beach cart will be increased when the beach cart is folded, which makes it inconvenient to carry and store.

### BRIEF SUMMARY OF THE INVENTION

In view of the defects of the prior art, the objective of the invention is to provide a cart capable of sliding without increasing the height.

To fulfill the above objective, the invention adopts the following technical solution: a cart capable of sliding without increasing the height comprises a cart frame formed by a front wall, a back wall and two symmetric side walls, a bottom frame at a bottom of the cart frame, and four wheels disposed on two sides of the front wall and two sides of the back wall respectively, wherein the front wall comprises two vertical tubes, two upper fixed seats, two lower fixed seats, two sliding seats and a folding member, the upper fixed seats and the lower fixed seats are mounted at upper ends and lower ends of the vertical tubes respectively, the sliding seats are disposed around the vertical tubes and are able to slide upwards and downwards, upper and lower ends of each same side of the folding member are riveted to the corresponding upper fixed seat and the corresponding sliding seat respectively, the folding member comprises two X-shaped tubes which are riveted together, and each of the X-shaped tubes is formed by two cross tubes which are riveted together in a crossed manner; the back wall is identical in structure with the front wall;

Each of the side walls comprises two long tubes, two short tubes and two connecting tubes which are arranged symmetrically, wherein lower ends of the two long tubes are articulated together, and upper ends of the two long tubes are riveted to the corresponding upper fixed seats of the front wall and the back wall respectively; lower ends of the two short tubes are riveted to the corresponding sliding seats respectively, upper ends of the two short tubes are articulated with upper ends of the connecting tubes, and the two short tubes are riveted to upper sections of the two long tubes; and lower ends of the two connecting tubes are riveted to lower sections of the two long tubes;

The bottom frame comprises a center seat and four bottom tubes symmetrically disposed at four corners of the center seat, one end of each of the four bottom tubes is riveted to an end of the center seat, and the other end of each of the four bottom tubes is riveted to the corresponding lower fixed seat.

Further, limit assemblies are disposed at tops of the vertical tubes, each limit assembly comprises an end cap, a U-shaped elastic element and a positioning pin, the end cap is downwards inserted into the corresponding vertical tube, a pin on a side of the U-shaped elastic element in the end cap penetrates through an end cap through-hole and a vertical tube through-hole to abut against a rear end of the positioning pin, and a front end of the positioning pin protrudes to stretch out of a limit hole of the corresponding upper fixed seat.

Further, articulation members are used for articulation, each articulation member comprises a left rivet piece and a right rivet piece which are symmetric in structure, one end of the left rivet piece and one end of the right rivet piece are rotatably connected, and the other end of the left rivet piece or other end of the right rivet piece is inserted into the corresponding long tube, the corresponding short tube, the corresponding connecting tube, or one cross tube of the corresponding X-shaped tube to be fixed.

Further, the upper fixed seats are L-shaped, first assembly slots which are open downwards are formed in two ends of each of the upper fixed seats, and the long tubes or cross tubes are inlaid in the first assembly slots to be riveted.

Further, second assembly slots which are open upwards are formed in the lower fixed seats towards the center seat, and one of each bottom tube is inlaid in the corresponding second assembly slot to be riveted; or, third assembly slots which are open downwards are formed in bottoms of four corners of the center seat towards the four lower fixed seats, and the other end of each bottom tube is inlaid in the corresponding third assembly slot to be riveted.

Further, the sliding seats are L-shaped, fourth assembly slots which are open upwards are formed in two ends of each of the sliding seats respectively, and the cross tubes or the short tubes are inlaid in the fourth assembly slots to be riveted.

Further, the cart further comprises a handlebar assembly disposed on the back wall, the handlebar assembly comprises a handlebar, an upper pull tube, a handlebar seat and two symmetric lower pull tubes, the handlebar is disposed around an upper end of the upper pull tube, the upper pull tube is fixed to an upper end of the handlebar seat, and upper and lower ends of each lower pull tube are riveted to the handlebar seat and the corresponding lower fixed seat respectively.

Furthermore, the cart further comprises pull tube connectors, grooves are formed in upper ends of the pull tube connectors, notches are formed in sides, close to a center, of the grooves, and the lower pull tubes stretch into the grooves to be riveted and are able to rotate leftwards and rightwards along the notches; and protrusions at lower ends of the pull tube connectors are riveted to front ends of the lower fixed seats and are able to rotate forwards and backwards.

Further, the wheels on the front wall are directional wheels, and the wheels on the back wall are universal wheels.

Further, wheel carriers are disposed at upper ends of the wheels, wheel axles are fixed to upper ends of the wheel carriers, and upper ends of the wheel axles are inserted into the vertical tubes.

The invention has the following beneficial effects: the sliding seats can slide upwards and downwards along the vertical tubes to allow the front wall, the back wall and the side walls of the cart to be folded towards their center to reduce the area, the handlebar assembly can be folded towards the back wall, the bottom frame can be folded by lifting the center seat of the bottom frame, and after being folded, the cart has a size smaller than that of the cart in use; after being folded through the sliding seats, the cart is not higher than the vertical tubes, and the height of the cart is not increased, so the cart can be stored, carried and transported more easily; and the cart can be folded to be stored and unfolded to be used conveniently and rapidly, and the space occupied by the cart is effectively reduced.

### BRIEF DESCRIPTION OF THE SEVERAL VIEWS OF THE DRAWINGS

FIG. 1 is a three-dimensional view of a cart capable of sliding without increasing the height;

FIG. 2 is a side view of the cart capable of sliding without increasing the height;

FIG. 3 is a front view of the cart capable of sliding without increasing the height;

FIG. 4 is an exploded view of a main part of the cart capable of sliding without increasing the height;

FIG. 5 is an exploded view of a handlebar assembly;

FIG. 6 is an exploded view of an upper fixed seat and a vertical tube.

In the figures: 1, front wall; 11, vertical tube; 11a, vertical tube through-hole; 12, upper fixed seat; 12a, first assembly slot; 12b, limit hole; 13, lower fixed seat; 13a, second assembly slot; 14, sliding seat; 14a, fourth assembly slot; 15, folding member; 151, X-shaped tube; 16, end cap; 16a, end cap through-hole; 17, U-shaped elastic element; 18, positioning pin; 2, back wall; 3, side wall; 31, long tube; 32, short tube; 33, connecting tube; 4, bottom frame; 41, center seat; 41a, third assembly slot; 42, bottom tube; 5, wheel; 51, wheel axle; 52, wheel carrier; 6, handlebar assembly; 61, handlebar; 62, upper pull tube; 63, handlebar seat; 63a, vertical through-hole; 64, lower pull tube; 65, pull tube connector; 65a, groove; 65b, notch; 65c, protrusion; 66, gasket; 67, spring; 7, articulation member; 71, left rivet piece; 72, right rivet piece.

### DETAILED DESCRIPTION OF THE INVENTION

To gain a better understanding of the technical solutions of the invention, the specific solutions and embodiments of the invention will be further expounded below in conjunction with the accompanying drawings.

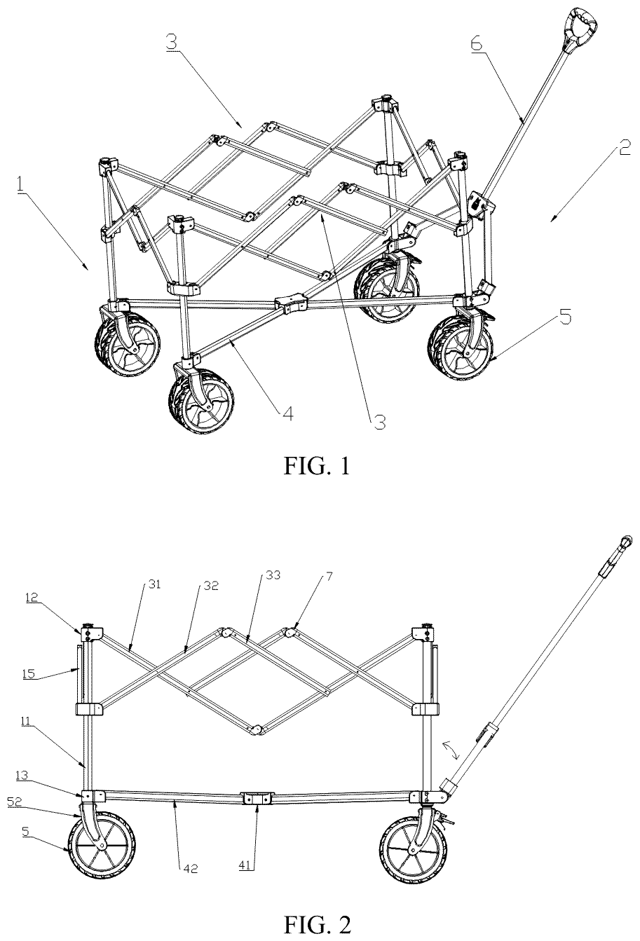

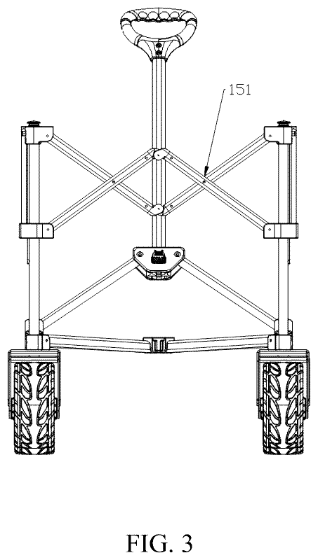

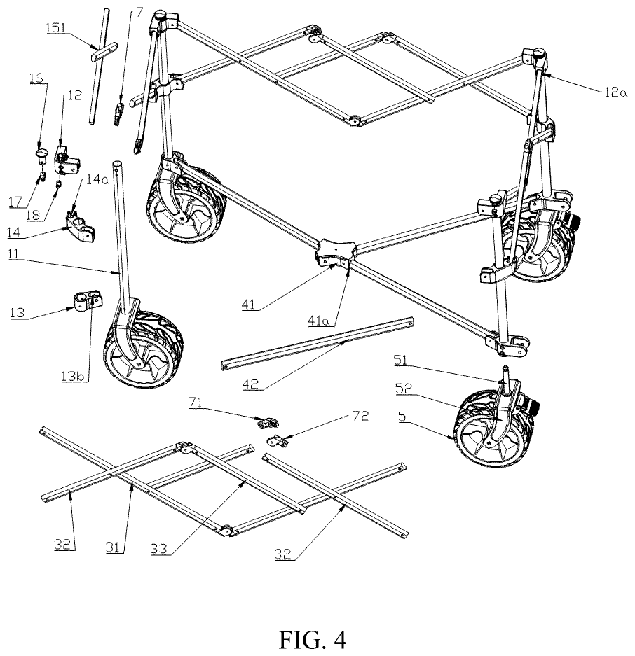

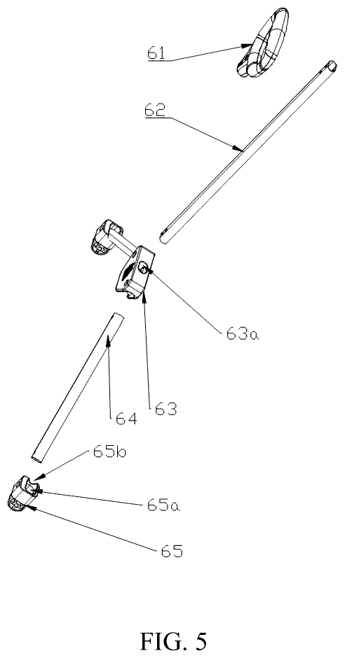

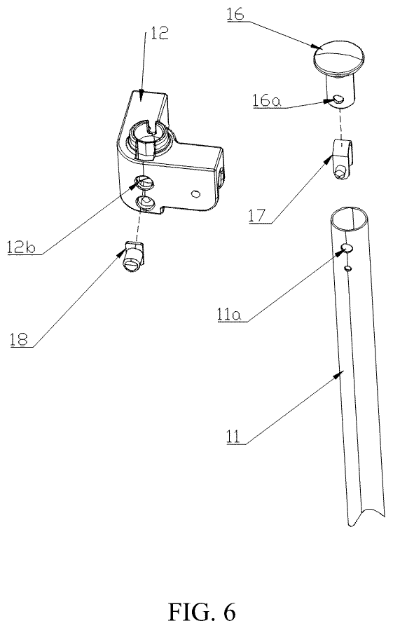

As shown in FIG. 1-FIG. 6, this embodiment provides a cart capable of sliding without increasing the height, which comprises a cart frame formed by a front wall 1, a back wall 2 and two symmetric side walls 3, a bottom frame 4 located at the bottom of the cart frame, and four wheels 5 disposed on two sides of the front wall and two sides of the back wall respectively.

Wherein, the front wall 1 comprises two vertical tubes 11, two upper fixed seats 12, two lower fixed seats 13, two sliding seats 14 and a folding member 15, wherein the upper fixed seats 12 and the lower fixed seats 13 are fixed at two ends of the vertical tubes 11 respectively, the sliding seats 14 are disposed around the vertical tubes 11 and are able to slide upwards and downwards, upper and lower ends of each same side of the folding member 15 are riveted to the corresponding upper fixed seat 12 and the corresponding sliding seat 14 respectively, and the folding member 15 can be folded to reduce the size and area of the front wall 1. The back wall 2 is identical in structure with the front wall 1.

In one embodiment, the folding member 15 comprises two X-shaped tubes which are articulated together, and each X-shaped tube is formed by two cross tubes which are articulated together. The two riveted cross tubes can be folded to allow the two articulated X-shaped tubes to be folded towards the center, such that the horizontal area of the front wall or the back wall is reduced by folding the folding member 15.

Each side wall 3 comprises two long tubes 31, two short tubes 32 and two connecting tubes 33 which are arranged symmetrically, wherein lower ends of the two long tubes 31 are articulated together, and upper ends of the two long tubes 31 are riveted to the corresponding upper fixed seats 12 of the front wall 1 and the back wall 2 respectively; lower ends of the two short tubes 32 are riveted to the corresponding sliding seats 14 respectively, upper ends of the two short tubes 32 are articulated with upper ends of the connecting tubes 33, and the two short tubes 32 are riveted to upper sections of the two long tubes 31; and lower ends of the two connecting tubes 33 are riveted to lower sections of the two long tubes 31. Every two riveted tubes can rotate to allow the side walls 3 to be folded toward the center, such that the horizontal area of the side walls 3 is reduced.

The bottom frame 4 comprises a center seat 41 and four bottom tubes 42, wherein each of four corners of the center base 41 are riveted to one end of one bottom tube 42, and the other end of each bottom tube 42 is riveted and connected to one of the four lower fixed seats 13. The four bottom tubes 42 can be folded towards the center by lifting the center seat, such that the bottom frame 4 is folded.

In a preferred embodiment, “articulated” involved in this embodiment is realized through articulation members. The articulation member 7 comprises a left rivet piece 71 and a right rivet piece 72 which are symmetric in structure, wherein one end (circuit end) of the left rivet piece 71 and one end (circular end) of the right rivet piece 72 are rotatably connected, and the other end (square end) of the left rivet piece 71 or other end (square end) of the right rivet piece 72 is inserted into an end of one long tube 31, one short tube 32, one connecting tube 33, or one cross tube of the corresponding X-shaped tube 151 and is fixed through a fastener (such as a screw), such that rotatable connection of the side walls 3, the front wall 1 or the back wall 2 is realized through the articulation members formed by the left rivet piece 71 and the right rivet piece 72, and each side of the cart frame of the cart can be unfolded or folded.

Because the sliding seats 14 are mounted on the vertical tubes 11, in order to improve the assembly firmness of the upper fixed seats 12, limit assemblies are disposed at the tops of the vertical tubes 11. Each limit assembly comprises an end cap 16, a U-shaped elastic element 17 and a positioning pin 18, wherein the lower end of the end cap 16 is inserted into the corresponding vertical tube 11, a pin on one side of the U-shaped elastic element 17 in the end cap 16 penetrates through an end cap through-hole 16a and a vertical tube through-hole 11a to abut against the rear end of the positioning pin 18, the positioning pin 18 is mounted in the corresponding upper fixed seat 12, the front end of the positioning pin 18 protrudes to stretch out of a limit hole 12b of the corresponding upper fixed seat 12, and the rear end of the positioning pin 18 is an arc-shaped surface matched with the tube wall of the vertical tube 11. The end caps 16 cover openings of the vertical tubes 11. The upper fixed seats 12 are fixed on the vertical tubes 11 through fasteners such as screws, and the screws are mounted below the limit holes 12a.

In one embodiment, the upper fixed seats 12 are L-shaped, first assembly slots 12a which are open downwards are formed in two ends of each of the upper fixed seats 12, and the long tubes 31 or cross tubes are inlaid in the first assembly slots 12a to be riveted.

In one embodiment, second assembly slots 13a which are open upwards are formed in the lower fixed seats 13 towards the center seat 41, and one end of each bottom tube 42 is inlaid in the corresponding second assembly slot 13a to be riveted.

In one embodiment, third assembly slots 41a which are open downwards are formed in the bottoms of the four corners of the center seat 41 towards the four lower fixed seats 13, and the other end of each bottom tube 42 is inlaid in the corresponding third assembly slot 41a to be riveted.

In one embodiment, the sliding seats 14 are L-shaped, fourth assembly slots 14a which are open upwards are formed in two ends of each of the sliding seats 14 respectively, the two ends of each of the sliding seats 14 correspond to the front wall 1 (or back wall 2) and the corresponding side wall 3 respectively, and the cross tubes or the short tubes are inlaid in the fourth assembly slots 14a to be riveted.

Wheel carriers 52 are disposed at upper ends of the wheels, wheel axles 51 are fixed to upper ends of the wheel carriers 52, and upper ends of the wheel axles 51 are inserted into the vertical tubes 11. The wheels on the front wall 1 are directional wheels, and the wheels on the back wall 2 provided with the handlebar 6 are universal wheels, such that the direction of the cart can be adjusted freely in case of a turn when goods are transported through the cart. Brakes are disposed on the wheels, and the brakes adopt a tire brake system in Patent Publication No. CN217575319U.

To pull the cart easily, a handlebar assembly 6 is disposed on the back wall 2, and comprises a handlebar 61, an upper pull tube 62, a handlebar seat 63, two symmetric lower pull tubes 64 and two pull tube connectors 65, wherein one end of each of the two lower pull tubes 64 is riveted to the lower side of the handlebar seat 63 and is able to rotate towards the center, the other end of each of the two lower pull tube 64 is riveted to one pull tube connector 65, and each pull tube connector 65 is riveted to the front side of one lower fixed seat 14; the handlebar 61 is disposed at the upper end of the upper pull tube 62, the lower end of the upper pull tube 62 penetrates through a vertical through-hole 63a of the handlebar seat 63 to be movably connected to the handlebar seat 63, that is, the upper pull tube 62 is able to slide upwards and downwards in the through hole. Through the pull tube connectors 65, the upper pull tube 62, the handlebar seat 63 and the lower pull tubes 64 can be drive to rotate towards the lower fixed seats 14 to be close to the back wall 2, and the upper pull tube 62 can slide downwards to drive the handlebar 61 to be close to the handlebar seat 63, such that the whole handlebar assembly is folded.

Specifically, grooves 65a are formed in upper ends of the pull tube connectors 65, notches 65b are formed in sides, close to the center, of the grooves, and the lower pull tubes 64 stretch into the grooves to be riveted and are able to rotate leftwards and rightwards along the notches; and protrusions 65c at lower ends of the pull tube connectors 65 are riveted to front ends of the lower fixed seats 13 and are able to rotate forwards and backwards.

In one embodiment, the sliding seats 14 are directly disposed around the vertical tubes 11 and are able to slide upwards and downwards, the diameter of vertical through-holes in the sliding seats 14 is greater than the diameter of the vertical tubes 11, and the sliding seats 14 are disposed around the vertical tubes 11 through the vertical through-holes and are able to slide upwards and downwards along the vertical tubes 11 freely.

When the cart is assembled, the front wall 1, the back wall 2, the side walls 3, the bottom frame 4 and the wheel assemblies 5 are assembled respectively, then the front wall 1, the back wall 2 (specifically the upper fixing seats 12 and the lower fixing seats 13), the two side walls 3, the bottom frame 4 and the handlebar assembly 6 are assembled together, and the wheels 5 are detachably mounted at the bottoms of the vertical tubes 12 specifically by inlaying the wheel axles 51 in the bottoms of the vertical tubes 12.

In this embodiment, a bag may be disposed on the bottom frame of the cart frame of the cart to be used for storing small and scattered articles. Preferably, the bag may be a rectangular bag without an upper surface, and four sides of the bag are detachably connected to the front wall, the back wall and the side walls of the cart frame respectively.

It should be noted that the preferred embodiments and the technical principle of the invention are described above. Those skilled in the art should understand that the invention is not limited to those specific embodiments described here, and can make various obvious changes, readjustments and substitutions without departing from the protection scope of the invention. So, although the invention has been described in detail with reference to the above embodiments, the invention is not limited to the these embodiments and may include more other equivalent embodiments without departing from the concept of the invention, and the scope of the invention should be defined by the scope of the appended claims.

What is claimed is:

1. A cart capable of sliding without increasing a height, said cart comprising:
a cart frame formed by a front wall, a back wall and two symmetric side walls, a bottom frame at a bottom of the cart frame, and four wheels disposed on two sides of the front wall and two sides of the back wall respectively;
wherein the front wall comprises two vertical tubes, two upper fixed seats, two lower fixed seats, two sliding seats and a folding member;
the upper fixed seats and the lower fixed seats are mounted at upper ends and lower ends of the vertical tubes respectively; the sliding seats are disposed around the vertical tubes and are able to slide upwards and downwards, upper and lower ends of each same side of the folding member are riveted to the corresponding upper fixed seat and the corresponding sliding seat respectively;
the folding member comprises two X-shaped tubes which are riveted together, and each of the X-shaped tubes is formed by two cross tubes which are riveted together in a crossed manner;
the back wall is identical in structure with the front wall;
each of the side walls comprises two long tubes, two short tubes and two connecting tubes which are arranged symmetrically; lower ends of the two long tubes are articulated together, and upper ends of the two long tubes are riveted to the corresponding upper fixed seats of the front wall and the back wall respectively;
lower ends of the two short tubes are riveted to the corresponding sliding seats respectively, upper ends of the two short tubes are articulated with upper ends of the connecting tubes, and the two short tubes are riveted to upper sections of the two long tubes; and lower ends of the two connecting tubes are riveted to lower sections of the two long tubes;
the bottom frame comprises a center seat and four bottom tubes symmetrically disposed at four corners of the center seat, one end of each of the four bottom tubes is riveted to an end of the center seat, and the other end of each of the four bottom tubes is riveted to the corresponding lower fixed seat.

2. The cart capable of sliding without increasing the height according to claim 1, wherein limit assemblies are disposed at tops of the vertical tubes, each said limit assembly comprises an end cap, a U-shaped elastic element and a positioning pin, the end cap is downwards inserted into the corresponding vertical tube, a pin on a side of the U-shaped elastic element in the end cap penetrates through an end cap through-hole and a vertical tube through-hole to abut against a rear end of the positioning pin, and a front end of the positioning pin protrudes to stretch out of a limit hole of the corresponding upper fixed seat.

3. The cart capable of sliding without increasing the height according to claim 1, wherein articulation members are used for articulation, each said articulation member comprises a left rivet piece and a right rivet piece which are symmetric in structure, one end of the left rivet piece and one end of the right rivet piece are rotatably connected, and the other end of the left rivet piece or other end of the right rivet piece is inserted into the corresponding long tube, the corresponding short tube, the corresponding connecting tube, or one cross tube of the corresponding X-shaped tube to be fixed.

4. The cart capable of sliding without increasing the height according to claim 1, wherein the upper fixed seats are L-shaped, first assembly slots which are open downwards are formed in two ends of each of the upper fixed seats, and the long tubes or cross tubes are inlaid in the first assembly slots to be riveted.

5. The cart capable of sliding without increasing the height according to claim 1, wherein second assembly slots which are open upwards are formed in the lower fixed seats towards the center seat, and an end of each said bottom tube is inlaid in the corresponding second assembly slot to be riveted; or, third assembly slots which are open downwards are formed in bottoms of four corners of the center seat towards the four lower fixed seats, and the other end of each bottom tube is inlaid in the corresponding third assembly slot to be riveted.

6. The cart capable of sliding without increasing the height according to claim 1, wherein the sliding seats are L-shaped, fourth assembly slots which are open upwards are formed in two ends of each of the sliding seats respectively, and the cross tubes or the short tubes are inlaid in the fourth assembly slots to be riveted.

7. The cart capable of sliding without increasing the height according to claim 1, wherein the cart further comprises a handlebar assembly disposed on the back wall, the handlebar assembly comprises a handlebar, an upper pull tube, a handlebar seat and two symmetric lower pull tubes, the handlebar is disposed around an upper end of the upper pull tube, the upper pull tube is fixed to an upper end of the handlebar seat, and upper and lower ends of each said lower pull tube are riveted to the handlebar seat and the corresponding lower fixed seat respectively.

8. The cart capable of sliding without increasing the height according to claim 7, wherein the cart further comprises pull tube connectors, grooves are formed in upper ends of the pull tube connectors, notches are formed in sides, close to a center, of the grooves, and the lower pull tubes stretch into the grooves to be riveted and are able to rotate leftwards and rightwards along the notches; and protrusions at lower ends of the pull tube connectors are riveted to front ends of the lower fixed seats and are able to rotate forwards and backwards.

9. The cart capable of sliding without increasing the height according to claim 1, wherein the wheels on the front wall are directional wheels, and the wheels on the back wall are universal wheels.

10. The cart capable of sliding without increasing the height according to claim 1, wherein wheel carriers are disposed at upper ends of the wheels, wheel axles are fixed to upper ends of the wheel carriers, and upper ends of the wheel axles are inserted into the vertical tubes.
